(19) United States
(12) Patent Application Publication
(10) Pub. No.: US 2013/0222383 A1
(43) Pub. Date: Aug. 29, 2013

(54) MEDICAL IMAGE DISPLAY DEVICE AND MEDICAL IMAGE DISPLAY METHOD

(71) Applicant: Hiroki Taniguchi, Tokyo (JP)

(72) Inventor: Hiroki Taniguchi, Tokyo (JP)

(73) Assignee: HITACHI MEDICAL CORPORATION, Tokyo (JP)

(21) Appl. No.: 13/882,384

(22) PCT Filed: Oct. 28, 2011
(86) PCT No.: PCT/JP2011/074891

§ 371 Date: Apr. 29, 2013

(30) Foreign Application Priority Data
Nov. 12, 2010 (JP) 2010-253338

(51) Int. Cl. G06T 15/08

(52) U.S. Cl. CPC G06T 15/08
USPC 345/424

(57) ABSTRACT

In order to provide a medical image display device and a medical image display method capable of displaying a three-dimensional image at high-speed, a medical image display device including a display unit that displays a three-dimensional image created on the basis of cross-sectional images of an object includes a sliding unit that uses an angle of a projection surface and a projection method set for the three-dimensional image and a projected image creation unit that creates a projected image using voxel data after sliding and displays the projected image on the display unit.

### TECHNICAL FIELD

The present invention relates to a medical image display device and a medical image display method to display medical images obtained from medical image diagnostic apparatuses including an X-ray CT apparatus, an MRI apparatus, an ultrasonic apparatus, and an apparatus for nuclear medicine diagnosis and in particular, to a technique for displaying a medical image as a three-dimensional image.

### BACKGROUND ART

With the development of a medical image diagnostic apparatus in recent years, a reduction in the slice thickness or an increase in the image collection range is in progress, and the number of medical images used in one examination has dramatically increased. For this reason, there is a demand for interpreting how efficiently a large amount of image data, and the importance of medical images obtained from medical image diagnostic apparatuses, especially, a three-dimensional image constructed by stacking cross-sectional images, which are two-dimensional images, is increasing. Specific display methods of a three-dimensional image include a surface rendering method, a volume rendering method, a maximum intensity projection (MIP) method, a minimum intensity projection (MinIP) method, a ray summation method, a multi-planar reconstruction (MPR) method, and the like. In these display methods, each time the position of a viewing point, the angle of the projection surface, scaling, and the like corresponding to the purpose of diagnostic imaging are set for a large amount of data of 512³ or more voxels, a projected image is created. Accordingly, in order to improve the efficiency of diagnostic imaging, it is necessary to increase the operation speed when creating the projected image.

PTL 1 discloses increasing the speed in creating the three-dimensional image by limiting the projection direction to the arrangement direction of voxels on the cross-sectional image.

### CITATION LIST

### Patent Literature

[PTL 1] JP-A-2001-283249

### SUMMARY OF INVENTION

### Technical Problem

In the method disclosed in PTL 1, however, consideration has not been made for the case where projection in an arbitrary direction is necessary since the projection direction is limited to the arrangement direction of voxels on the cross-sectional image.

Therefore, it is an object of the present invention to provide a medical image display device and a medical image display method capable of displaying a three-dimensional image in an arbitrary direction at high-speed.

### Solution to Problem

In order to achieve the above-described object, in the present invention, an array of voxels that form a three-dimensional image is rearranged on a memory according to the angle of the projection surface and the projection method, and a projected image is created using the voxel data after rearrangement. Since high-speed access to data on the memory is possible due to using the voxel data after rearrangement, high-speed display of the projected image is possible.

Specifically, a medical image display device of the present invention is a medical image display device including a display unit that displays a three-dimensional image created on the basis of cross-sectional images of an object, and is characterized in that it includes: a voxel sliding unit that slides each voxel, which forms the three-dimensional image, in one direction according to an angle of a projection surface and a projection method set for the three-dimensional image; and a projected image creation unit that creates a projected image using voxel data after sliding and displays the projected image on the display unit.

In addition, a medical image display method of the present invention is a medical image display method for displaying a three-dimensional image created on the basis of cross-sectional images of an object, and is characterized in that it includes: a voxel sliding step of sliding each voxel, which forms the three-dimensional image, in one direction according to an angle of a projection surface and a projection method set for the three-dimensional image; and a projected image creation step of creating a projected image using voxel data after sliding and displaying the projected image.

### Advantageous Effects of Invention

According to the present invention, it is possible to provide a medical image display device and a medical image display method capable of displaying a three-dimensional image at high speed.

### BRIEF DESCRIPTION OF DRAWINGS

FIG. 1 is the hardware configuration of a medical image display device of the present invention.

FIG. 2 is the process flow of the first embodiment of the present invention.

FIG. 3 is an example of a three-dimensional image created on the basis of cross-sectional images.

FIG. 4 is an example of a GUI for setting a display parameter of a three-dimensional image.

FIG. 5 is an example of a GUI for setting a parameter of an operation image.

FIG. 6 is an example of the process flow of step 204.

FIG. 7 is a diagram for explaining the positional relationship between the three-dimensional image and the projection surface.

FIG. 8 is a diagram for supplementary explanation of a shear image.

FIG. 9 is a diagram for supplementary explanation of the calculation of the amount of sliding within the plane 801 in the case of parallel projection.

FIG. 10 is a diagram for supplementary explanation of the calculation of the amount of sliding in the case of perspective projection.

FIG. 11 is a diagram for supplementary explanation of the operation target region after sliding.

FIG. 12 is a diagram for supplementary explanation of a state after sliding voxels in a direction perpendicular to cross-sectional images.

FIG. 13 is an example of a GUI for setting a display parameter when the projection surface is a curved surface.

### DESCRIPTION OF EMBODIMENTS

Hereinafter, preferred embodiments of a medical image display device according to the present invention will be described according to the accompanying drawings. In addition, in the following explanation and the accompanying drawings, the same reference numerals are given to components with the same functions, and repeated explanation thereof will be omitted.

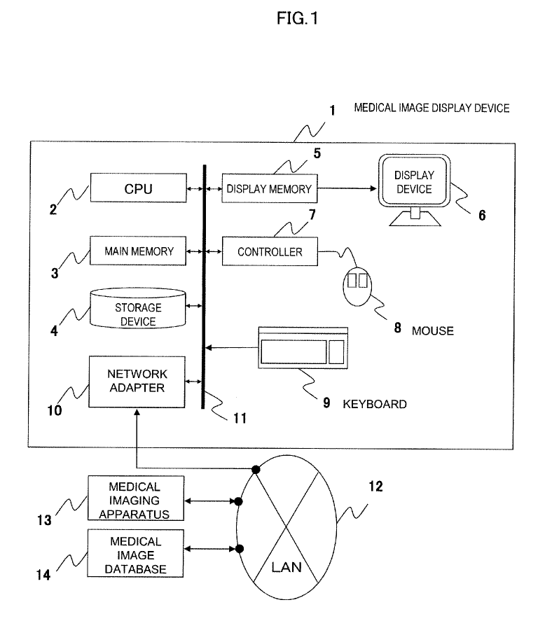

FIG. 1 is a diagram showing the hardware configuration of a medical image display device 1. The medical image display device 1 is configured to include a CPU (Central Processing Unit) 2, a main memory 3, a storage device 4, a display memory 5, a display device 6, and a controller 7 connected to a mouse 8, a keyboard 9, and a network adapter 10, all of which are connected to each other through a system bus 11 so that signals can be transmitted and received to and from each other. The medical image display device 1 is connected to a medical imaging apparatus 13 or a medical image database 14 through a network 12 so that signals can be transmitted and received to and from each other. Here, “signals can be transmitted and received to and from each other” indicates a state where signals can be transmitted and received to and from each other or can be transmitted and received from one to another regardless of wired or wireless electrically and optically.

The CPU 2 is a unit that controls the operation of each component. The CPU 2 loads a program stored in the storage device 4 or data required for program execution into the main memory 3 and executes it. The storage device 4 is a device that stores medical image information captured by the medical imaging apparatus 13. Specifically, the storage device 4 is a hard disk or the like. In addition, the storage device 4 may be a device that transmits and receives data to and from portable recording media, such as a flexible disc, an optical (magnetic) disc, a ZIP memory, and a USB memory. The medical image information is acquired from the medical imaging apparatus 13 or the medical image database 14 through the network 12, such as a LAN (Local Area Network). In addition, a program executed by the CPU 2 or data required for program execution is stored in the storage device 4. The main memory 3 stores the program executed by the CPU 2 or the progress of arithmetic processing.

The display memory 5 temporarily stores display data to be displayed on the display device 6, such as a liquid crystal display or a CRT (Cathode RayTube). The mouse 8 or the keyboard 9 is an operation device used when an operator gives an operation instruction to the medical image display device 1. The mouse 8 may be another pointing device, such as a trackpad or a trackball. The controller 7 detects the state of the mouse 8, acquires the position of the mouse pointer on the display device 6, and outputs the acquired position information and the like to the CPU 2. The network adapter 10 is for connecting the medical image display device 1 to the network 12, such as a LAN, a telephone line, and the Internet.

The medical imaging apparatus 13 is an apparatus that acquires medical image information, such as a cross-sectional image of an object. For example, the medical imaging apparatus 13 is an MRI apparatus, an X-ray CT apparatus, an ultrasonic diagnostic apparatus, a scintillation camera apparatus, a PET apparatus, or a SPECT apparatus. The medical image database 14 is a database system that stores medical image information captured by the medical imaging apparatus 13.

### First Embodiment

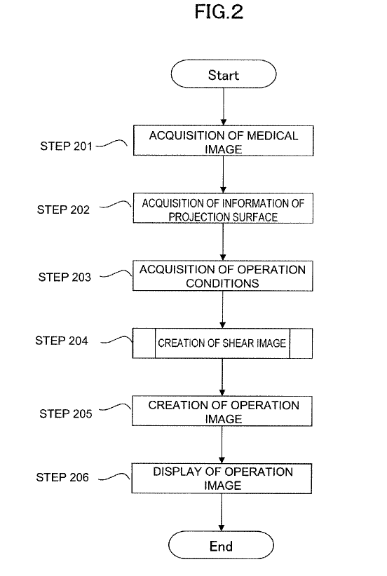

A first embodiment of the present invention will be described with reference to FIGS. 2 to 11. In the present embodiment, an array of voxels that form a three-dimensional image is rearranged on a memory according to the angle of the projection surface and the projection method, and a projected image is created using the voxel data of the voxels after rearrangement. FIG. 2 is an example of the process flow of the first embodiment of the present invention. Each step of FIG. 2 will be described below.

(Step 201)

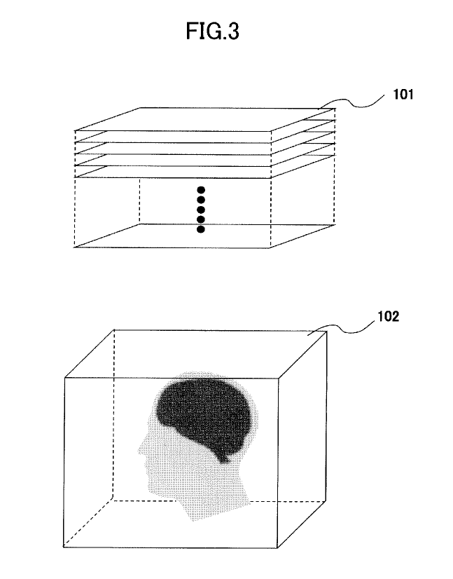

The CPU 2 acquires a medical image selected by the operator to operate the mouse 8 or the keyboard 9, as a three-dimensional image, from the medical imaging apparatus 13 or the medical image database 14 through the network 12. As shown in FIG. 3, a three-dimensional image 102 is created by stacking cross-sectional images 101 captured using a medical imaging apparatus. In addition, the medical image acquired in this step may be the entire three-dimensional image 102 shown in FIG. 3 or may be a specific region of the three-dimensional image 102. The specific region of the three-dimensional image 102 may be a region extracted by threshold value processing, which is executed by the CPU 2 using a threshold value set in advance, or may be a region designated by the operator to operate the mouse 8 or the keyboard 9.

(Step 202)

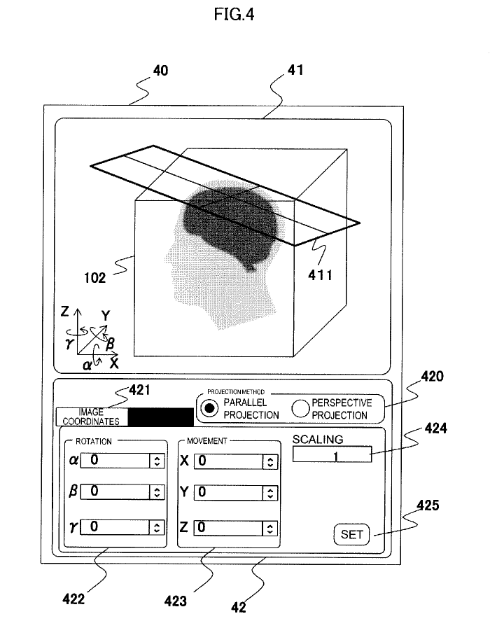

The CPU 2 acquires information regarding the viewing point or the projection surface set for a three-dimensional image that has been acquired in step 201 by the operator to operate the mouse 8 or the keyboard 9. An example of a GUI (Graphical User Interface) used when the operator sets the viewing point or the projection surface will be described in detail later with reference to FIG. 4.

(Step 203)

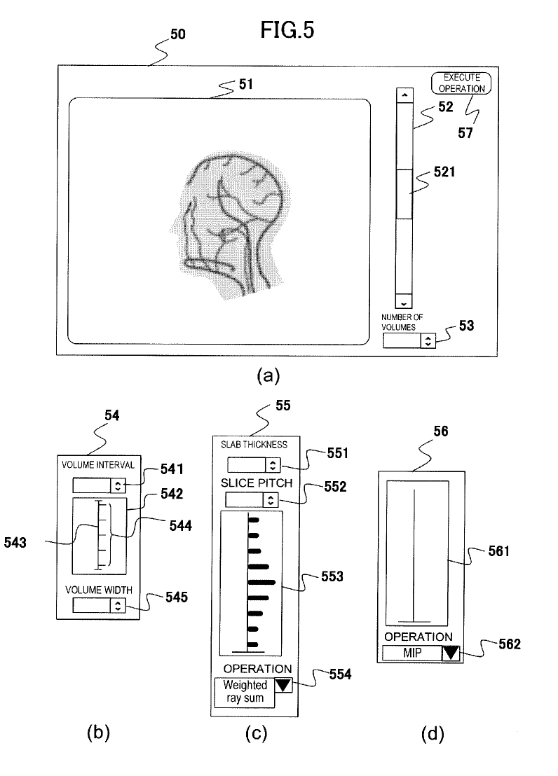

The CPU 2 acquires the conditions required when creating operation images. Here, the operation images are images, such as a surface rendering image, a volume rendering image, an MIP image, an MinIP image, a Ray summation image, and an MPR image. An example of the GUI used when the operator sets the operation image creation conditions will be described in detail later with reference to FIG. 5.

(Step 204)

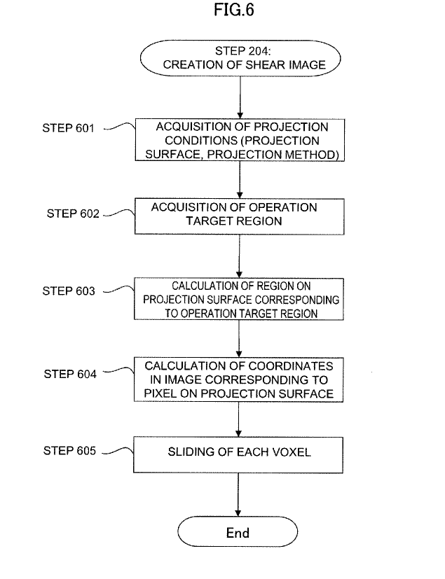

The CPU 2 creates a shear image on the basis of the parameter set in step 202. The shear image is an image created such that the projection line and voxels are arranged in parallel. In addition, this step may be executed in advance of step 203. A detailed example of the flow of the shear image creation processing will be described with reference to FIG. 6.

(Step 601)

The CPU 2 acquires projection conditions from the information set in step 202. The acquired projection conditions are positional relationship between the three-dimensional image 102 and the projection surface 411 and whether or not the projection method is parallel projection.

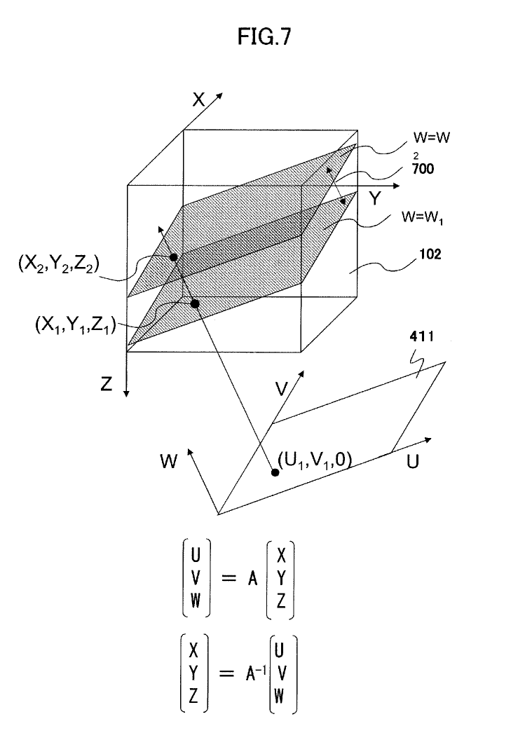

The positional relationship between the three-dimensional image 102 and the projection surface 411 will be described with reference to FIG. 7. In FIG. 7, an XYZ coordinate system is set in order to express the coordinates of voxels that form the three-dimensional image 102. In many cases, the Z axis is set as a body axis direction of the object, and the XY plane is a cross-sectional image. In addition, a UVW coordinate system is set as a coordinate system for expressing the projection surface, and the UV plane of W=0 is a projection surface.

The relationship between the XYZ coordinate system and the UVW coordinate system is expressed as in the following expression.

$$( \begin{matrix}U \\ V \\ W\end{matrix} ) = A ( \begin{matrix}X \\ Y \\ Z\end{matrix} ) \qquad [ Expression 1 ]$$

Here, A is an affine transformation matrix to convert the XYZ coordinate system into the UVW coordinate system, and includes rotation, movement, and scaling.

By multiplying both sides of Expression 1 by the inverse matrix A⁻¹ of A and exchanging both sides, the following expression is obtained. Thus, the UVW coordinate system can be converted into the XYZ coordinate system.

$$( \begin{matrix}X \\ Y \\ Z\end{matrix} ) = {A}^{- 1} ( \begin{matrix}U \\ V \\ W\end{matrix} ) \qquad [ Expression 2 ]$$

The coordinates in the three-dimensional image 102 that are parallel-projected to the coordinates (U₁, V₁) on the projection surface 411 are calculated by setting any value of X, Y, Z, and W after substituting the coordinates (U₁, V₁) into Expression 2.

Whether or not the projection method is parallel projection is based on a projection method selected in a projection method selection portion 420.

(Step 602)

The CPU 2 acquires an operation target region from the information set in step 203. In step 203, the operation target region is set as a distance from the projection surface 411, that is, a value of W by designating the position of a knob 521 of an operation region designation portion 52 and changing the length of the knob 521. FIG. 7 shows an example in which a region from the plane of W=W₁ to the plane of W=W₂ is set as an operation target region 700.

(Step 603)

The CPU 2 calculates a region on the projection surface 411 corresponding to the operation target region 700 acquired in step 602. Specifically, the CPU 2 extends the projection line from each voxel in the operation target region 700 onto the projection surface 411, and calculates the intersection coordinates (u, v) between the projection line and the projection surface 411. For example, when the voxel coordinates are (X₀, Y₀, Z₀), the values of U and V calculated by substituting (X₀, Y₀, Z₀) into Expression 1 are the intersection coordinates (u, v). The calculated intersection coordinates (u, v) do not necessarily match the center coordinates of the pixels on the projection surface 411. The CPU 2 calculates the region including all voxels and corresponding intersection coordinates (u, v) as a region on the projection surface corresponding to the operation target region 700.

In addition, this step is not essential. However, since a region to be treated on the projection surface is limited by executing this step, the amount of subsequent computation can be reduced and accordingly it is possible to increase the operation speed.

(Step 604)

The CPU 2 calculates the coordinates (x, y, z) in the three-dimensional image 102 corresponding to the pixel on the projection surface 411. Specifically, the CPU 2 extends the projection line from each pixel on the projection surface 411 to the three-dimensional image 102 and calculates the intersection coordinates (x, y, z) between each cross-sectional image, which forms the three-dimensional image 102 and is defined by the z coordinate, and the projection line. For example, when the pixel coordinates are (U₁, V₁) and the z coordinate of the cross-sectional image is Z₁, the value of W is first calculated by substituting (U₁, V₁) and Z₁ into Expression 2. Then, the values of X and Y are calculated by substituting the calculated value of W and (U₁, V₁) into Expression 2. As a result, the intersection coordinates (x, y, z) can be calculated. That is, if the pixel coordinates on the projection surface and the z coordinate of the cross-sectional image are set, the intersection coordinates (x, y, z) are calculated. In addition, the intersection coordinates (x, y, z) are present on the cross-sectional image but do not necessarily match the center coordinates of the pixels on the cross-sectional image.

(Step 605)

The CPU 2 creates a shear image by sliding each voxel on the basis of the intersection coordinates (x, y, z) calculated in step 604. The shear image is an image created such that the intersection between the projection line and each cross-sectional image is arranged in parallel to one of x, y, and z axes. For example, when the intersection between the projection line and each cross-sectional image is arranged in parallel to the z axis, the (x, y) coordinates on the projection line are the same. If such a shear image is created, in order to calculate the pixel value of the arbitrary pixel coordinates (U, V) on the projection surface, it is preferable to use only the voxel value of the voxel, which has the (x, y) coordinates corresponding to (U, V), among the voxels in the shear image. As a result, since high-speed access to data on the memory is possible, high-speed display of the projected image is possible.

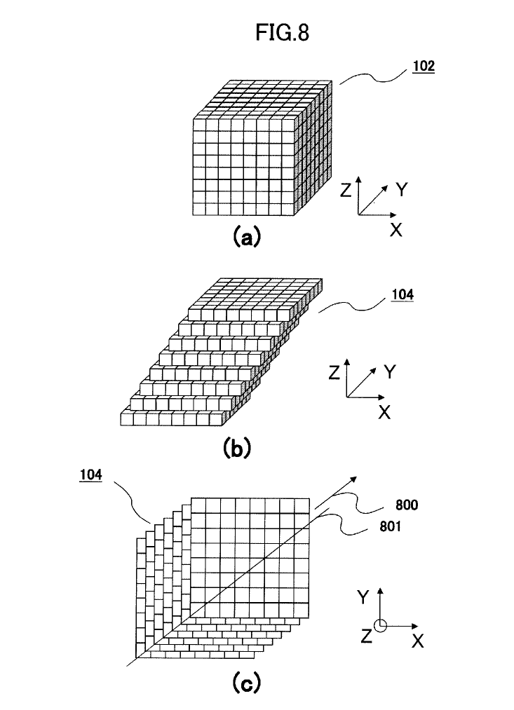

A shear image in the case of parallel projection will be described as an example with reference to FIG. 8. In FIG. 8, in order to simplify the drawing, the three-dimensional image 102 is expressed as 8³ voxels. FIG. 8(a) is a perspective view showing the three-dimensional image 102 in a state before the slide, and FIG. 8(b) is a perspective view showing a shear image 104 in a state after the slide. In addition, FIG. 8(c) shows the shear image 104 when viewed from the z-axis direction.

The shear image 104 shown in FIG. 8 is created by sliding each voxel, which forms the three-dimensional image 102, in parallel to the cross-sectional image so that the intersection between the projection line and each cross-sectional image is arranged in parallel to the z axis. In FIG. 8(b), each cross-sectional image slides in the same direction within the X-Y plane, that is, in a direction of arrow 800 in FIG. 8(c). In addition, in FIG. 8(b), the amount of sliding of each cross-sectional image is different for each cross-sectional image, but the difference in the amount of sliding between adjacent cross-sectional images is equal. The sliding direction and the amount of sliding are set by the positional relationship between the projection surface and the three-dimensional image.

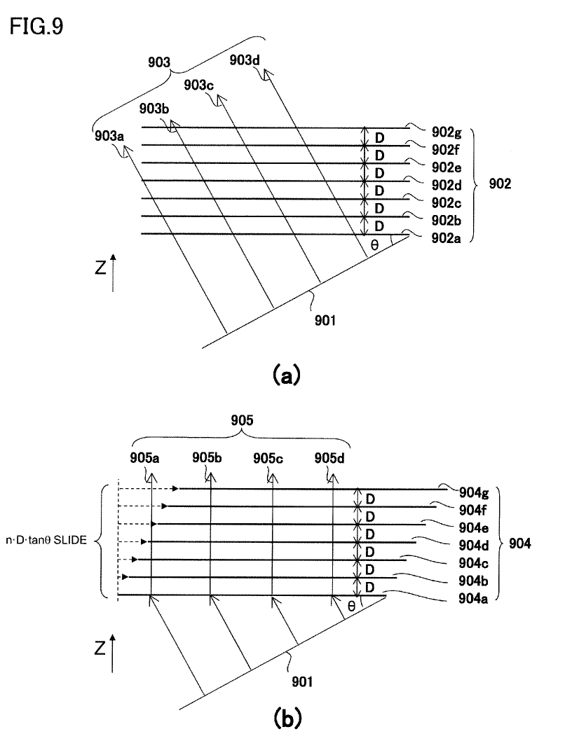

Here, in order to simply understand the amount of sliding, the amount of sliding within the plane 801 parallel to the arrow 800 and the z axis will be described with reference to FIG. 9.

FIG. 9 shows that a three-dimensional image 902 created by stacking cross-sectional images 902a to 902g in the z-axis direction is projected onto the projection surface 901. In addition, FIG. 9(a) shows a state before sliding the voxel of the three-dimensional image 902, and FIG. 9(b) shows a state after creating a shear image 904 by sliding the voxel. In addition, the slice distance between the cross-sectional images 902a to 902g is D, and the angle between the three-dimensional image 902 and the projection surface 901 is θ.

In order for the intersection between the projection line and each cross-sectional image to be arranged in parallel to the z axis, it is preferable to slide the cross-sectional images 902a to 902g by the predetermined amount in a direction parallel to the cross-sectional image. Cross-sectional images 904a to 904g are obtained by sliding the cross-sectional images 902a to 902g, and the shear image 904 is obtained by stacking the cross-sectional images 904a to 904g. Then, projection lines 903a to 903d become projection lines 905a to 905d, and the projection lines 905a to 905d become parallel to the z axis.

The amount of sliding s when sliding the voxel of the three-dimensional image 902 in a direction parallel to the cross-sectional image within the plane 801 is expressed as in the following expression.

S=n·D·tan θ [Expression 3]

Here, θ is an angle between the three-dimensional image and the projection surface, and D is a slice distance. n is a slice number from the reference cross-sectional image. For example, assuming that the reference cross-sectional image is the cross-sectional image 902a, n=1 in the cross-sectional image 902b and n=2 in the cross-sectional image 902c.

According to Expression 3, the amount of sliding of each voxel is calculated from the angle between the three-dimensional image and the projection surface and the distance from the reference cross-sectional image.

In addition, according to Expression 3, the amount of sliding s within the same cross-sectional image is a fixed value. However, since the amount of sliding s is not necessarily an integral multiple of the size of the voxel, interpolation calculation within the cross-sectional image, that is, within the x-y plane in FIG. 9 is required in order to calculate the voxel value on the projection line. In addition, since the voxel is made to slide in a direction parallel to the cross-sectional image, voxel value interpolation calculation in the projection direction is not necessary.

In addition, it is also possible to slide each voxel in a direction parallel to the cross-sectional image such that the projection direction becomes a stacking direction of cross-sectional images.

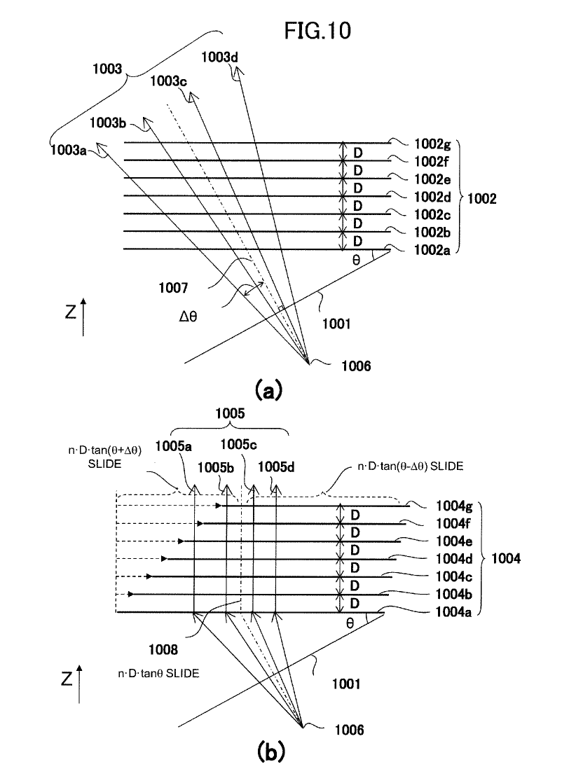

Next, in order to simply understand the amount of sliding in the case of perspective projection, it will be described with reference to FIG. 10. FIG. 10 is a diagram for explaining the amount of sliding within the plane including a centerline 1007 that passes through a viewing point 1006 and is perpendicular to the projection surface 1001. FIG. 10 shows that a three-dimensional image 1002 created by stacking cross-sectional images 1002a to 1002g is projected from the viewing point 1006 onto the projection surface 1001. In addition, FIG. 10(a) shows a state before sliding the voxel of the three-dimensional image 1002, and FIG. 10(b) shows a state after creating a shear image 1004 by sliding the voxel. In addition, the slice distance between the cross-sectional images 1002a to 1002g is D, and the angle between the three-dimensional image 1002 and the projection surface 1001 is θ.

In the case of perspective projection, since projection lines 1003a to 1003d extend radially from the viewing point 1006, the inclination of the projection line with respect to the projection surface 1001 is different for each projection line. Therefore, the inclination of the projection line with respect to the centerline 1007 is expressed as Δθ in FIG. 10. That is, Δθ of the projection line 1003a is larger than Δθ of the projection line 1003b.

Also in the case of perspective projection, similar to the case of parallel projection, the cross-sectional images 1002a to 1002g are made to slide by the predetermined amount in a direction parallel to the cross-sectional image so that the intersection between the projection line and each cross-sectional image is arranged in parallel to the z axis. Cross-sectional images 1004a to 1004g are obtained by sliding the cross-sectional images 1002a to 1002g, and the shear image 1004 is obtained by stacking the cross-sectional images 1004a to 1004g. Then, the projection lines 1003a to 1003d and the centerline 1007 become projection lines 1005a to 1005d and a centerline 1008, and the projection lines 1005a to 1005d and the centerline 1008 become parallel to the z axis.

The amount of sliding s when sliding the voxel of the three-dimensional image 1002 in a direction parallel to the cross-sectional image within the plane including the centerline 1007 is expressed as in the following expression.

S=n·D·tan(θ±Δθ) [Expression 4]

Here, θ is an angle between the three-dimensional image and the projection surface, Δθ is an angle between the centerline 1007 and each projection line, and D is a slice distance. n is a slice number from the reference cross-sectional image. For example, assuming that the reference cross-sectional image is the cross-sectional image 1002a, n=1 in the cross-sectional image 1002b and n=2 in the cross-sectional image 1002c.

In addition, in Expression 4, the sign before Δθ is determined by the direction of each projection line. The sign is positive if the direction of each projection line with respect to the cross-sectional images 1002a to 1002g is more parallel to the cross-sectional images 1002a to 1002g than the centerline 1007 is, and is negative if the direction of each projection line with respect to the cross-sectional images 1002a to 1002g is more perpendicular to the cross-sectional images 1002a to 1002g than the centerline 1007 is. Specific explanation will be given with reference to FIG. 10(b). The amount of sliding s is n·D·tan θ in the voxel on the centerline 1007, n·D·tan(θ+Δθ) on the projection lines 1003a and 1003b, and n·D·tan(θ−Δθ) on the projection lines 1003c and 1003d. The directions of the projection lines 1003a and 1003b with respect to the cross-sectional images 1002a to 1002g are more parallel to the cross-sectional images 1002a to 1002g than the centerline 1007 is, and the directions of the projection lines 1003c and 1003d with respect to the cross-sectional images 1002a to 1002g are more perpendicular to the cross-sectional images 1002a to 1002g than the centerline 1007 is. In addition, although all voxels are made to slide from left to right in FIG. 10(b), all voxels are made to slide in the opposite direction in the case of Δθ>0 since the value of n·D·tan(θ−Δθ) is negative.

According to Expression 4, the amount of slidings of each voxel is calculated from the angle between the projection surface and the projection line and the distance from the reference cross-sectional image. That is, in the case of perspective projection, even in the same cross-sectional image, the amount of sliding s becomes a different value according to the inclination of the projection lines 1003a to 1003d with respect to the cross-sectional images 1002a to 1002g.

In addition, according to Expression 4, since the amount of sliding s is not necessarily an integral multiple of the size of the voxel, interpolation calculation within the cross-sectional image, that is, within the x-y plane in FIG. 10 is required in order to calculate the voxel value on the projection line. In addition, since the voxel is made to slide in a direction parallel to the cross-sectional image, voxel value interpolation calculation in the projection direction is not necessary.

In addition, it is also possible to slide each voxel in a direction parallel to the cross-sectional image such that the projection direction becomes a stacking direction of cross-sectional images.

In addition, assuming that the value of Δθ in Expression 4 is 0, Expression 4 is the same as Expression 3. This indicates that parallel projection is realized if the point at infinity is set as a viewing point of perspective projection.

(Step 205)

The CPU 2 creates an operation image using the shear image created in step 204. A known method can be used as a method of creating an operation image. Since the projection line and the voxel are arranged in parallel in the shear image, high-speed access to voxel value data on the memory is possible. As a result, an operation image can be created at high speed.

In addition, since the correspondence between the pixel on the projection surface and the voxel used when calculating the pixel value of the pixel can be handled using the coordinates of the pixel, data management becomes easy.

In addition, when creating an operation image, it is also possible to divide a shear image into a plurality of regions, to create an operation image for each of the divided regions and to set it as an in-volume image when necessary. In addition, it is also possible to create an inter-volume image by performing various operations between a plurality of in-volume images.

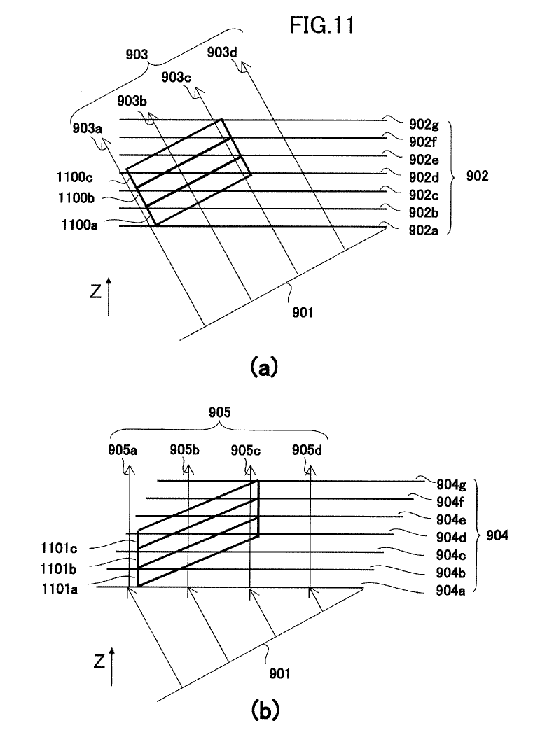

Next, the relationship between the shear image and the in-volume image and the inter-volume image will be described with reference to FIG. 11. Similar to FIG. 9, FIG. 11 shows that the three-dimensional image 902 created by stacking the cross-sectional images 902a to 902g is projected onto the projection surface 901. Regions to be calculated 1100a to 1100c are set in the three-dimensional image 902. In addition, FIG. 11(a) shows a state before sliding the voxel of the three-dimensional image 902, and FIG. 11(b) shows a state after creating the shear image 904 by sliding the voxel. The operation target regions 1100a to 1100c in the three-dimensional image 902 become operation target regions 1101a to 1101c in the shear image 904.

Since the in-volume image is created for each of the operation target regions 1100a to 1100c, three in-volume images are created in FIG. 11. When creating the in-volume image, the projection line and the voxel are arranged in parallel by using the shear image shown in FIG. 11(b). Accordingly, since voxel value interpolation calculation in the projection direction is not necessary, it is possible to increase the operation speed.

Increasing the operation speed by using the shear image shown in FIG. 11(b) is also possible when creating the inter-volume image. When performing an operation among three in-volume images created for the operation target regions 1100a to 1100c, voxels are arranged obliquely with respect to the projection line in a state before sliding the voxels. Therefore, depending on the position on the projection line, voxel value interpolation calculation in the projection direction is required. In contrast, in a state after creating the shear image 904 by sliding the voxel, the voxel value interpolation calculation in the projection direction is not required. Therefore, it is also possible to increase the operation speed when creating the inter-volume image.

(Step 206)

The CPU 2 displays the operation image created in step 205 on the display device 6. In addition, when the operator determines that he or she wants to re-create the displayed operation image and such operation is made, the process returns to step 203 or step 202.

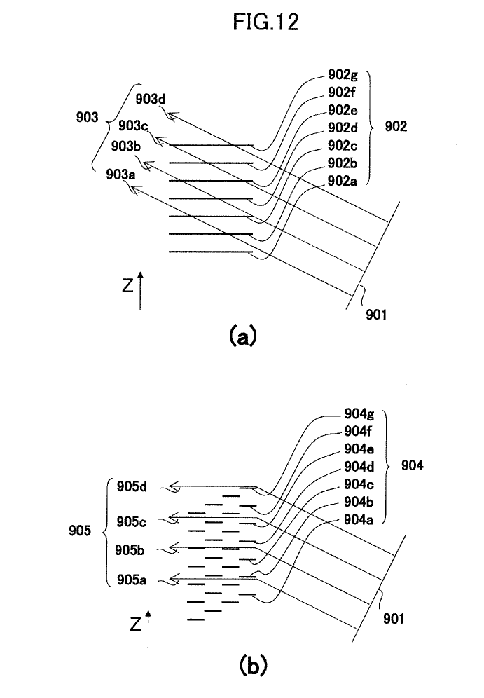

In the explanation so far, the voxels of the cross-sectional images 902a to 902g are made to slide in the direction parallel to the cross-sectional image. However, even if the voxels are made to slide in a direction perpendicular to the cross-sectional image, it is possible to create a shear image in which the projection line and the voxel are arranged in parallel. FIG. 12 shows an example when sliding voxels in a direction perpendicular to the cross-sectional images 902a to 902g. When sliding the voxels as shown in FIG. 12, the directions of the projection lines 905a to 905d after sliding become directions parallel to the cross-sectional images 902a to 902g. Here, considering that a three-dimensional image is created by stacking cross-sectional images, it is desirable to slide the voxels in the direction parallel to the cross-sectional images.

Thus, by creating the shear image in which the projection line and the voxel are arranged in parallel, parallel processing based on SIMD (Single Instruction Multiple Data) processing can be performed using the continuity of memory space of the shear image when performing projection processing. That is, it is possible to complete the projection processing for each projection line.

In addition, using the independence of memory space of the shear image, it is possible to divide memory space to be processed in units of a thread and to perform pipeline processing for each thread. Therefore, an increase in the speed when creating the operation image from the three-dimensional image can be realized by creating the shear image.

FIG. 4 shows an example of a GUI used in step 202, that is, a GUI used when the operator sets the viewing point or the projection surface. A GUI 40 shown in FIG. 4 includes an image display portion 41 and a display parameter setting portion 42.

The three-dimensional image 102 and the viewing point or the projection surface 411 are displayed in the image display portion 41. The display form of the three-dimensional image 102 and the projection surface 411 displayed in the image display portion 41 changes according to the display parameter set in the display parameter setting portion 42.

The display parameter setting portion 42 has a projection method selection portion 420, a coordinate system selection portion 421, a rotation angle setting portion 422, a movement amount setting portion 423, and a magnification setting portion 424. In the projection method selection portion 420, either parallel projection or perspective projection can be selected as a projection method. The parallel projection is a method of projecting projection lines by extending the projection lines in the same direction from the viewing point set at the point at infinity, and all the projection lines are parallel to each other. The perspective projection is a method of projecting projection lines by extending the projection lines radially from a certain viewing point, and is also called central projection. In both the projection methods, the pixel value of the intersection between the projection surface 411 and each projection line is determined using the voxel value of the intersection between the three-dimensional image 102, which is an object to be projected, and the projection line. Although the radio button is used in the projection method selection portion 420 in FIG. 4, the present invention is not limited to this. Since parallel projection is selected in FIG. 4, the viewing point is a point at infinity and is not displayed in the image display portion 41.

In the coordinate system selection portion 421, either the image coordinates or the projection coordinates can be selected. The image coordinates are the coordinate system corresponding to the three-dimensional image 102, and the projection coordinates are the coordinate system corresponding to the viewing point or the projection surface 411. For the coordinate system selected in the coordinate system selection portion 421, parameters set in the rotation angle setting portion 422 and the movement amount setting portion 423 are effective. Although a tab is used as the coordinate system selection portion 421 in the projection method selection portion 420 in FIG. 4, the present invention is not limited to this. In FIG. 4, the image coordinates are selected.

In the rotation angle setting portion 422, the rotation angle around each axis of the coordinate system selected in the coordinate system selection portion 421 can be set. α, β, and γ indicate rotation angles around X, Y, and Z axes, respectively. Each time any value of α, β, and γ is updated, the coordinate system selected in the coordinate system selection portion 421 rotates, and an image corresponding to the coordinate system rotates with the rotation and is updated on the image display portion 41. In addition, when the image coordinates are selected in the coordinate system selection portion 421, the viewing point or the projection surface 411 may be rotated in conjunction with the three-dimensional image 102. Although the combination of the editing field and the spin button is used in the rotation angle setting portion 422 in FIG. 4, the present invention is not limited to this.

In the movement amount setting portion 423, it is possible to set the amount of movement in each axis direction of the coordinate system selected in the coordinate system selection portion 421. Each time any value of X, Y, and Z is updated, the coordinate system selected in the coordinate system selection portion 421 moves, and an image corresponding to the coordinate system moves with the movement and is updated on the image display portion 41. In addition, when the image coordinates are selected in the coordinate system selection portion 421, the viewing point or the projection surface 411 may be made to move in conjunction with the three-dimensional image 102. Although the combination of the editing field and the spin button is used in the movement amount setting portion 423 in FIG. 4, the present invention is not limited to this.

In the magnification setting portion 424, it is possible to set the magnification when displaying an image corresponding to the coordinate system selected in the coordinate system selection portion 421. Since an image having a size obtained by multiplication of the value set as a magnification is displayed, an image is displayed in the actual size if 1 is set as the magnification. Although the editing field is used in the magnification setting portion 423 in FIG. 4, the present invention is not limited to this.

In addition, the operator may perform rotation, movement, enlargement by performing a dragging operation of the three-dimensional image 102 and the viewing point or the projection surface 411, which are displayed on the image display portion 41, using the mouse 8. In the case of rotation, movement, and enlargement using a dragging operation, it is preferable to update the parameter values corresponding to the operation on the rotation angle setting portion 422, the movement amount setting portion 423, and the magnification setting portion 424.

FIG. 5 shows an example of a GUI used in step 203, that is, a GUI used when the operator sets the operation image creation conditions. A GUI 50 shown in FIG. 5(a) includes an operation image display portion 51, an operation region designation portion 52, a volume number setting portion 53, and an operation execution button 57.

An in-volume image or an inter-volume image created as an operation image is displayed in the operation image display portion 51. Here, the in-volume image is an image created by executing an operation on the volume data in a region designated as an operation target. In addition, the inter-volume image is an image created by executing various operations between a plurality of in-volume images. The operation executed when creating the inter-volume image may be different from the operation executed when creating the in-volume image.

The operation region designation portion 52 is used to designate the position and the region of an operation target. In FIG. 5(a), a scroll bar is used as the operation region designation portion 52, and the position of an operation target is designated by moving the knob 521 on the scroll bar. The direction of the scroll bar corresponds in a direction perpendicular to the projection surface set in step 202. In addition, the length of the knob 521 is variable, and the region of the operation target can be changed by changing the length of the knob 521. A volume designation portion 54, which will be described later, is displayed by operation of locating the mouse cursor on the knob 521.

The volume number setting portion 53 is used to set the number of volumes which are objects of the operation between volumes. The length of the knob 521 increases as the numerical value set in the volume number setting portion 53 increases. If the numerical value set in the volume number setting portion 53 is 1, an operation image displayed on the operation image display portion 51 is an in-volume image. In addition, the numerical value displayed in the volume number setting portion 53 may be changed with the change of the length of the knob 521.

FIG. 5(b) shows an example of the volume designation portion 54. The volume designation portion 54 has a volume interval setting portion 541, a volume number display portion 542, and a volume width setting portion 545. The volume interval setting portion 541 is used to set the volume interval, and the volume width setting portion 545 is used to set the volume width. An axis 543 and gradations 544 are displayed in the volume number display portion 542. The number of volumes is expressed as the number of gradations 544. The interval between the gradations 544 changes according to the value of the volume interval. The length of the axis 543 changes according to the value of the volume width. An in-volume image creation condition setting portion 55, which will be described later, is displayed by clicking the gradations 544. In order to indicate which of the gradations 544 has been clicked, it is possible to display a knob on the clicked gradations. An inter-volume image creation condition setting portion 55, which will be described later, is displayed by clicking between the gradations 544.

FIG. 5(c) shows an example of the in-volume image creation condition setting portion 55. The in-volume image creation condition setting portion 55 has a slab thickness setting portion 551, a slice pitch setting portion 552, an operation parameter setting portion 553, and an operator selection portion 554. The slab thickness setting portion 551 is used to set the slab thickness of a target region of the in-volume image. The slice pitch setting portion 552 is used to set the slice pitch in a target region of the in-volume image. The operator selection portion 554 is used to select the operator used in creating the in-volume image. In the operator selection portion 554, it is possible to select the type of operator performed on the volume data. Although the pull-down menu is used in the operator selection portion 554 in FIG. 5(c), the present invention is not limited to this. Types of operation include an arithmetic operation, a comparison operation, and an in-volume operation. Hereinafter, types of each operation will be described.

The arithmetic operation is an operation using four operations, and there is a weighted sum as an example. Specifically, there are a Ray sum to apply the same weighting to all, a weighted Ray sum to set the weighting coefficient for each cross-sectional image and perform weighted product-sum operation between cross-sectional images, subtraction using negative values as some weighting coefficients, α blending for making the sum of weighting coefficients becoming 1, and the like.

The comparison operation is an operation of determining the pixel value on the projection surface by comparing the voxel values on the projection line. Specifically, there are MIP operation of projecting the maximum voxel value on the projection line onto the projection surface, MinIP operation of projecting the minimum voxel value on the projection line onto the projection surface, and the like.

The in-volume operation is an operation that does not depend on the pixel position on the projection surface. Specifically, there are Rendering for creating a projected image on the basis of the opacity, which is set according to the voxel value, and Crystal (count image) for setting the weighting coefficient for each voxel value and performing weighted product-sum operation between cross-sectional images.

In the operation parameter setting portion 553, parameters required for a setting are displayed according to the operator selected in the operator selection portion 554. The operator can change the parameters displayed in the operation parameter setting portion 553 by operating the mouse or the like. In the example shown in FIG. 5(c), weighted Ray sum is selected as an operator, and weighting coefficients are displayed in the operation parameter setting portion 553.

FIG. 5(d) shows an example of the inter-volume image creation condition setting portion 56. The inter-volume image creation condition setting portion 56 has an operation parameter setting portion 561 and an operator selection portion 562. The operator selection portion 562 is used to select the operator used in creating the inter-volume image, and is the same as the operator selection portion 554 in FIG. 5(c). In the operation parameter setting portion 561, parameters required for a setting are displayed according to the operator selected in the operator selection portion 562. The operator can change the parameters displayed in the operation parameter setting portion 561 by operating the mouse or the like. In the example shown in FIG. 5(d), MIP is selected as an operator. Since there is no parameter required for a setting in the case of MIP operation, nothing is displayed in the operation parameter setting portion 561.

In addition, GUIs used when setting the operation image creation conditions are not limited to those shown in FIG. 5.

After the above-described operator selection and parameter setting, when the operator presses the operation execution button 57 by operating the mouse 8, the processing of the CPU 2 proceeds to step 204.

### Second Embodiment

A second embodiment of the present invention will be described with reference to the drawings. The case where the projection surface 411 is a flat surface has been described in the first embodiment. In the present embodiment, a case where a curved surface can be selected as a projection surface will be described. When diagnosing a hollow organ, such as blood vessels or the colon, the diagnosis can be easily performed by creating a cross-sectional image that is parallel to the traveling direction of the hollow organ. In order to create a cross-sectional image parallel to the traveling direction of the hollow organ, it is necessary to treat a curved surface as a projection surface.

The process flow in the second embodiment is approximately the same as in FIG. 4. However, the GUI used in step 202 and the flow of the processing executed in step 203 are different. Hereinafter, differences from the first embodiment will be described.

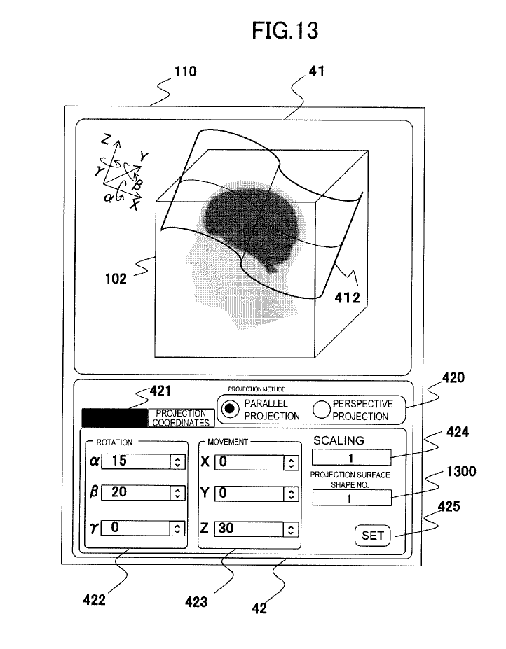

FIG. 13 is an example of a GUI used in the second embodiment. The difference from the GUI 40 used in the first embodiment shown in FIG. 4 will be described. A GUI 110 used in the present embodiment includes a projection surface shape designation portion 1300. In the projection surface shape designation portion 1300, the shape of the projection surface can be designated. Various projection surface shapes and projection surface shape identification numbers, which are numbers for identifying the respective projection surface shapes, are stored in the storage device 4 so as to match each other. The operator selects a desired projection surface shape by inputting the projection surface shape identification number in the projection surface shape designation portion 1100. In addition, although not shown in FIG. 11, it is also possible to use a GUI allowing the partial curvature of the projection surface to be set. In addition, in FIG. 11, the projection coordinates are selected in the coordinate system selection portion 421.

When the projection surface is a curved surface, the shape of the operation target region acquired in step 602 of FIG. 6 becomes a shape along the projection surface that is a curved surface, and other steps are the same process as in FIG. 6. That is, also when the projection surface is a curved surface, an increase in the speed when creating the operation image from the three-dimensional image can be realized by creating the shear image.

In addition, the medical image display device of the present invention is not limited to the embodiments described above.

### REFERENCE SIGNS LIST

1: MEDICAL IMAGE DISPLAY DEVICE
2: CPU
3: MAIN MEMORY
4: STORAGE DEVICE
5: DISPLAY MEMORY
6: DISPLAY DEVICE
7: CONTROLLER
8: MOUSE
9: KEYBOARD
10: NETWORK ADAPTER
11: SYSTEM BUS
12: NETWORK
13: MEDICAL IMAGING APPARATUS
14: MEDICAL IMAGE DATABASE
101: CROSS-SECTIONAL IMAGE
102: stacked three-dimensional image

1. A medical image display device including a display unit that displays a three-dimensional image created on the basis of cross-sectional images of an object, comprising:
a voxel sliding unit that slides each voxel, which forms the three-dimensional image, in one direction according to an angle of a projection surface and a projection method set for the three-dimensional image; and
a projected image creation unit that creates a projected image using voxel data after sliding and displays the projected image on the display unit.

2. The medical image display device according to claim 1,
wherein the voxel sliding unit determines an amount of sliding of each voxel according to an inclination of each projection line with respect to the projection surface.

3. The medical image display device according to claim 2,
wherein, when the projection method is parallel projection, the amount of sliding is fixed within the same cross-sectional image.

4. The medical image display device according to claim 2,
wherein, when the projection method is perspective projection, the amount of sliding differs depending on the inclination of each projection line with respect to the projection surface.

5. The medical image display device according to claim 1,
wherein the voxel sliding unit slides each voxel in a direction parallel to the cross-sectional image.

6. The medical image display device according to claim 1, further comprising:
a projection condition reception unit that receives a setting of the angle of the projection surface and the projection method.

7. A medical image display method for displaying a three-dimensional image created on the basis of cross-sectional images of an object, comprising:
a voxel sliding step of sliding each voxel, which forms the three-dimensional image, in one direction according to an angle of a projection surface and a projection method set for the three-dimensional image; and
a projected image creation step of creating a projected image using voxel data after sliding and displaying the projected image.

8. The medical image display method according to claim 7,
wherein, in the voxel sliding step, an amount of sliding of each voxel is determined according to an inclination of each projection line with respect to the projection surface.

9. The medical mage display method according to claim 8,
wherein, when the projection method is parallel projection, the amount of sliding is fixed within the same cross-sectional image.

10. The medical image display method according to claim 8,
wherein, when the projection method is perspective projection, the amount of sliding differs depending on the inclination of each projection line with respect to the projection surface.

11. The medical image display method according to claim 7,
wherein, in the voxel sliding step, each voxel is made to slide in a direction parallel to the cross-sectional image.

12. The medical image display method according to claim 7, further comprising:
a projection condition reception step of receiving a setting of the angle of the projection surface and the projection method, which is performed before the voxel sliding step.
